(19) United States
(12) Patent Application Publication
(10) Pub. No.: US 2010/0098484 A1
(43) Pub. Date: Apr. 22, 2010

(54) QUICK RELEASE DEVICE FOR A PEDAL

(76) Inventor: Chung-I Chen, Taichung Hsien (TW)

Correspondence Address: Chien-Hui Su, P. O. Box 70-121 Taichung, Taichung City, 40899, TW

(21) Appl. No.: 12/254,005

(22) Filed: Oct. 19, 2008

(51) Int. Cl. F16B 1/00

(52) U.S. Cl. 403/321; 403/380

(57) ABSTRACT

A quick release device for a pedal includes a spindle, a connecting unit connected to the spindle, and a quick release mechanism connected to the connecting unit. The spindle has a protrusion extending from one end thereof and an annular groove defined in an outer peripheral thereof. The connecting unit has a receiving hole defined therein, a guiding hole defined in a lateral thereof and communicated with the receiving hole, and a retaining hole defined therein and communicated with the receiving hole. The quick release mechanism includes a rod partially received in the guiding hole and a spring biased against the rod toward the receiving hole. In assembly the protrusion engages with the retaining hole and the rod engages with the annular groove.

### BACKGROUND OF THE INVENTION

1. Field of the Invention

The present invention relates to a quick release device, and more particularly to a quick release device for a pedal.

2. Description of Related Art

Bicycle pedals are typically connected to the crank by screw bolts and nuts. This connecting method does not permit the rider to quickly and easily detach the pedal from the crank. A conventional quick release device in accordance with the prior art comprises a fixing threaded sleeve screwed on the rotation shaft of the pedal and a crank arm formed with locking recess for locking and fixing the fixing threaded sleeve. The crank arm of the conventional quick release device is needed to machine the locking recess, and therefore the conventional quick release device does not fit all the crank arms on the market. Moreover, the connection between the crank arm and the threaded sleeve will loosen after the long time riding. That is dangerous for rider when the pedal is detached from the crank arm.

The present invention has arisen to mitigate and/or obviate the disadvantages of the conventional quick release device.

### SUMMARY OF THE INVENTION

The main objective of the present invention is to provide an improved quick release device, and more particular to a quick release device for a pedal, which permits the pedal to be assembled with or detached from the crank easily and quickly.

To achieve the objective, the quick release device for a pedal in accordance with the present invention includes a spindle, a connecting unit connected to the spindle, and a quick release mechanism connected to the connecting unit. The spindle has a protrusion extending from one end thereof and an annular groove defined in an outer peripheral thereof. The connecting unit has a receiving hole defined therein for partially receiving the spindle and a guiding hole defined in a lateral thereof and communicated with the receiving hole. The connecting unit has a retaining hole defined therein and communicated with the receiving hole. The quick release mechanism includes a rod partially received in the guiding hole and a spring biased against the rod toward the receiving hole. In assembly the protrusion engages with the retaining hole and the rod engages with the annular groove. When pulling the rod, the rod disengages with the annular groove. Therefore, the spindle is free to be detached from the connecting unit.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a quick release device for a pedal in accordance with the present invention;

FIG. 2 is an assembled perspective view of the quick release device in FIG. 1;

FIG. 3 is a cross-sectional view of the quick release device taken along line A-A in FIG. 2; and

FIG. 4 is an operational cross-sectional view of the quick release device in accordance with the present invention, showing the spindle is detached from the connecting unit.

### DETAILED DESCRIPTION OF THE INVENTION

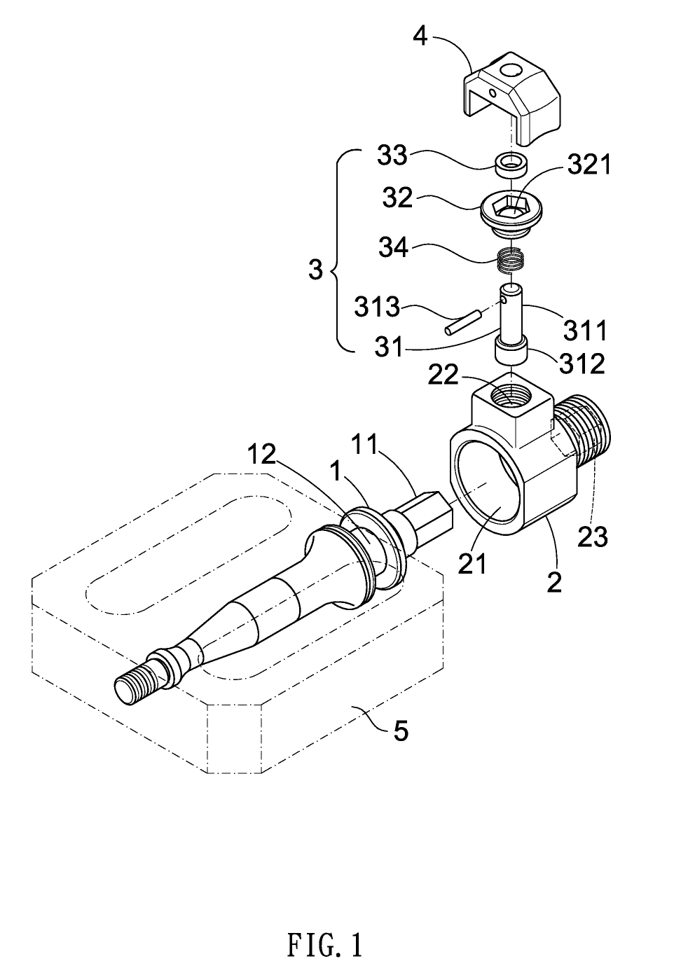

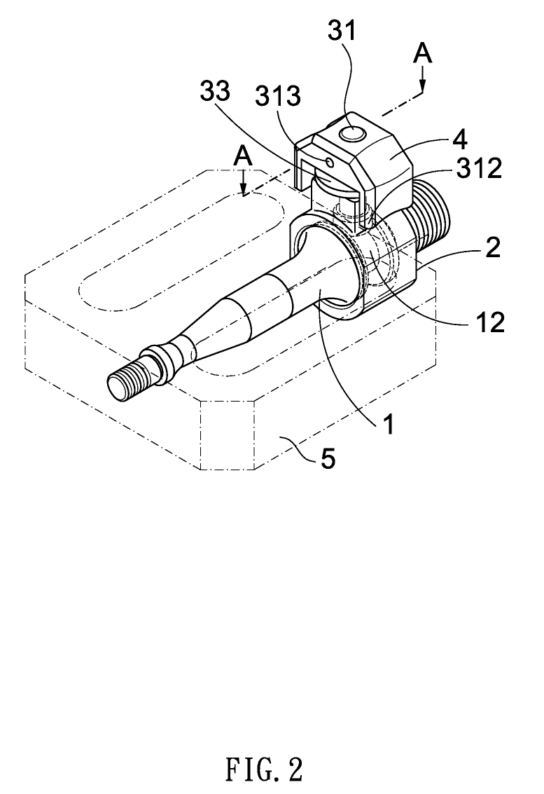

Referring to the drawings and initially to FIGS. 1-2, a quick release device for a pedal in accordance with the present invention comprises a spindle 1, a connecting unit 2 connected to the spindle 1, a quick release mechanism 3 partially received in the connecting unit 2, and a housing 4 connected to the quick release mechanism 3.

One end of the spindle 1 is formed with a threaded portion (not numbered) for adapting to be mounted to a pedal 5. The spindle 1 has a protrusion 11 coaxially extending from the other end thereof. The protrusion 11 is in a shaped of polygon for assembling with the connecting unit 2. The spindle 1 has an annular groove 12 defined in an outer peripheral thereof and being adjacent to the protrusion 11.

The connecting unit 2 has a receiving hole 21 defined therein for partially receiving the spindle 1. The connecting unit 2 has a guiding hole 22 defined in a lateral thereof and communicated with the receiving hole 21 for partially receiving the quick release mechanism 3. The guiding hole 22 is perpendicular to the receiving hole 21 and corresponds to the annular groove 12 in the spindle 1 when in assembly. The connecting unit 2 has a retaining hole 23 defined therein and communicated with the receiving hole 21. The retaining hole 23 is coaxial with the receiving hole 21. The retaining hole 23 is complementary to the protrusion 11 for engaging with the protrusion 11. One end of the connecting unit 2 which is opposite to the receiving hole 21 is formed with a threaded portion (not numbered) for adapting to be mounted to a crank.

The quick release mechanism 3 comprises a rod 31 received in the guiding hole 22, a spring 34 connected to the rod 31, a fastener 32 screwed to the guiding hole 22. The rod 31 has a shank portion 311 formed therein and a head portion 312 extended from one end thereof. A diameter of the head portion 312 is greater than that of the shank portion 311. The spring 34 is sleeved on the shank portion 311. One end of the spring 34 is fixed to the fastener 32 and the other end of the spring 34 is abutted to the head portion 312 such that biasing against the rod 31 toward the receiving hole 21. The diameter of the head portion 312 is substantially equal to a width of the annular groove 12 for securely engaging the head portion 312 with the annular groove 12. The fastener 32 has a through hole 321 defined therein for passing the shank portion 311. The fastener 32 has a polygon hole (not numbered) defined therein and coaxially communicated with through hole 321. The polygon hole is provided to be inserted by a tool for screwing the fastener 32. The quick release mechanism 3 further comprises a ring 33 received in the polygon hole. The ring 33 is made of soft materials and is lubricated. The ring 33 is sleeved on the shank portion 3 11 for lubricating and guiding. The housing 4 covers the quick release mechanism 3 for keeping the quick release mechanism 3 from dust and water. The quick release mechanism 3 further comprises a pin 313 passing through the housing 4 and the shank potion 311 such that the rod 31 moves with the housing 4 along an axis of the guiding hole 22 when pulling the housing 4.

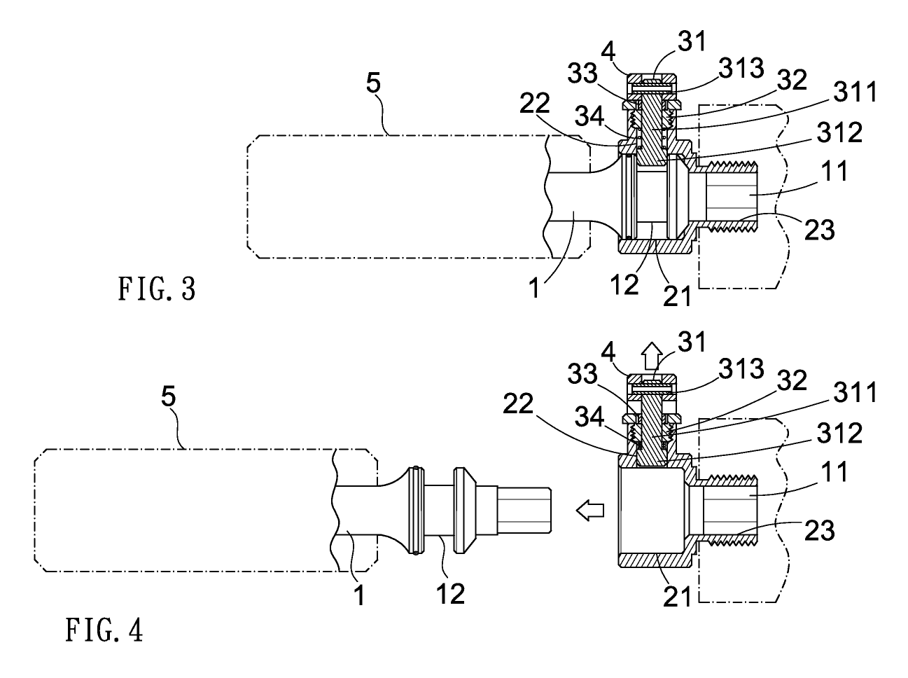

Referring to FIG. 3, in assembly, the spindle 1 is inserted into the receiving hole 21. The protrusion 11 engages with the retaining hole 23 such that the spindle 1 does not rotate relative to the connecting unit 2. In the meantime, the head portion 312 of the rod 31 engages with the annular groove 12 in the spindle 1, therefore the spindle 1 is firmly secured with the connecting unit 2. The rod 31 is subjected to a spring force to keep engaging with the annular groove 12. Furthermore, the annular groove 12 is provided to engage with the rod 31 at any angle to enhance flexibility.

Referring to FIG. 4, when pulling the housing 4, the rod 31 moves with the housing 4. In the meantime, the head portion 312 disengages with the annular groove 12. The spindle 1 together with the pedal 5 is free to be detached from the connecting unit 2.

Although the invention has been explained in relation to its preferred embodiment, it is to be understood that many other possible modifications and variations can be made without departing from the spirit and scope of the invention as hereinafter claimed.

What is claimed is:

1. A quick release device for a pedal, comprising:
a spindle having a protrusion extending from one end thereof and an annular groove defined in an outer peripheral thereof;
a connecting unit connected to the spindle, the connecting unit having a receiving hole defined therein for partially receiving the spindle, the connecting unit having a guiding hole defined in a lateral thereof and communicated with the receiving hole, the connecting unit having a retaining hole defined therein and communicated with the receiving hole; and
a quick release mechanism connected to connecting unit, the quick release mechanism comprising a rod partially received in the guiding hole and a spring biased against the rod toward the receiving hole;
whereby in assembly the protrusion engages with the retaining hole and the rod engages with the annular groove.

2. The quick release device for a pedal as claimed in claim 1, wherein the rod has a shank portion and an enlarged head portion extending from one end thereof, a diameter of the head portion being substantially equal to a width of the annular groove.

3. The quick release device for a pedal as claimed in claim 2, wherein the quick release mechanism further comprises a fastener screwed to the guiding hole, the fastener having a through hole defined therein for passing the shank portion.

4. The quick release device for a pedal as claimed in claim 1 further comprising a housing connected to the rod and a pin passing through the housing and the rod, wherein the rod moves with the housing along the guiding hole when pulling the housing.

5. The quick release device for a pedal as claimed in claim 1, wherein the quick release mechanism further comprises a ring sleeved on the rod, wherein the ring is made of soft materials and lubricated.

6. The quick release device for a pedal as claimed in claim 1, wherein the spindle has a threaded portion formed in one end thereof for adapting to be mounted to the pedal.

7. The quick release device for a pedal as claimed in claim 1, wherein the connecting unit has a threaded portion formed in one end thereof for adapting to be mounted to a crank.

8. The quick release device for a pedal as claimed in claim 1, wherein the protrusion is in a shaped of polygon and the retaining hole is complementary to the protrusion for engaging with the protrusion.
